(19) United States
(12) Patent Application Publication
(10) Pub. No.: US 2026/0016682 A1
(43) Pub. Date: Jan. 15, 2026

(54) POSITIONING STRUCTURE FOR HOLDING TWO PARALLEL LENSES OF ENDOSCOPE RELATIVE TO EACH OTHER

(71) Applicant: MEDICAL INTUBATION TECHNOLOGY CORPORATION, Taoyuan City (TW)

(72) Inventor: Shih-Wei LO, Taoyuan City (TW)

(21) Appl. No.: 19/217,533

(22) Filed: May 23, 2025

(30) Foreign Application Priority Data
Jul. 12, 2024 (TW) 113126278

(51) Int. Cl. G02B 23/24; G02B 7/02

(52) U.S. Cl. CPC G02B 23/243; G02B 7/02

(57) ABSTRACT

A positioning structure for holding two parallel lenses of an endoscope relative to each other, including: a separating-positioning component having a first lens module fixed on a right side thereof, an abutting wall and two clamping walls disposed on a left side thereof, and a slot formed jointly by the abutting wall and the two clamping walls; and a second lens module having one end abutting against the abutting wall, being parallel to the first lens module, and being constrained by the two clamping walls and thus being unable to move forward and backward relative to the separating-positioning component. The second lens module is fixed to the separating-positioning component, allowing the first lens module and the second lens module to be positioned relative to each other using the separating-positioning component.

### BACKGROUND OF THE INVENTION

### 1. Technical Field

The present disclosure relates to endoscopes, and more particularly to a positioning structure for holding two parallel lenses of an endoscope relative to each other.

### 2. Description of Related Art

China patent CN 211381254U discloses a gastrointestinal endoscope with a 3D imaging camera having therein a main lens, first auxiliary camera, and second auxiliary camera. The imaging directions of the three lenses or cameras are oriented forward and arranged in a parallel configuration. An objective of CN 211381254U is to achieve 3D imaging using multiple lenses.

However, CN 211381254U has some disadvantages, as explained below. The main lens, first auxiliary camera, and second auxiliary camera are disposed on their support plates respectively and located on the same sides of the support plates; thus, although the imaging directions of the three lenses or cameras are parallel, CN 211381254U fails to disclose how to maintain fixed relative distances and positions among the main lens, first auxiliary camera, and second auxiliary camera to facilitate a fitting process. Furthermore, the relative distances and positions among the main lens, first auxiliary camera, and second auxiliary camera are closely related to their perceived stereoscopic depth and distance judgments. As a result, CN 211381254U fails to teach any specific mechanism configured to position the three lenses or cameras, leading to alignment inaccuracies or low yield during assembly.

### BRIEF SUMMARY OF THE INVENTION

It is an objective of the disclosure to provide a positioning structure for holding two parallel lenses of an endoscope relative to each other, effective in positioning the two parallel lenses relative to each other, fitting the two parallel lenses in place, ensuring that the two parallel lenses are positioned relative to each other as a result of the two parallel lenses being fixed in place, enhancing the precision of the fitting process, and enhancing the yield.

To achieve the above and other objectives, the disclosure provides a positioning structure for holding two parallel lenses of an endoscope relative to each other, comprising: a separating-positioning component having a predetermined height in a vertical direction, with a first lens module fixed on a right side thereof, an upright abutting wall defined on a left side thereof, clamping walls extending leftward from a front end and rear end of the abutting wall respectively so as to face each other and be upright, and a slot formed jointly by the abutting wall and the two clamping walls; and a second lens module being in shape of an upright rectangular column with a rectangular cross-section, having an end abutting against the abutting wall, being parallel to the first lens module, being constrained by the two clamping walls and thus being unable to move forward and backward relative to the separating-positioning component, wherein the second lens module is fixed to the separating-positioning component, allowing the first lens module and the second lens module to be positioned relative to each other using the separating-positioning component.

Therefore, the disclosure is effective in positioning two parallel lenses, namely the first lens module and the second lens module, relative to each other, fitting the two parallel lenses in place, ensuring that the two parallel lenses are positioned relative to each other as a result of the two parallel lenses being fixed in place, enhancing the precision of the fitting process, and enhancing the yield.

### BRIEF DESCRIPTION OF THE DRAWINGS

FIG. 1 is a perspective view according to the first preferred embodiment of the disclosure.

FIG. 2 is an exploded view according to the first preferred embodiment of the disclosure.

FIG. 3 is a partial exploded view according to the first preferred embodiment of the disclosure.

FIG. 4 is a schematic view according to the first preferred embodiment of the disclosure.

FIG. 5 is a partial exploded view according to another aspect of the first preferred embodiment of the disclosure.

FIG. 6 is a perspective view based on FIG. 5.

FIG. 7 is an exploded view according to the second preferred embodiment of the disclosure.

### DETAILED DESCRIPTION OF THE INVENTION

The technical features of disclosure are hereunder illustrated with preferred embodiments, depicted with accompanying drawings, and described below.

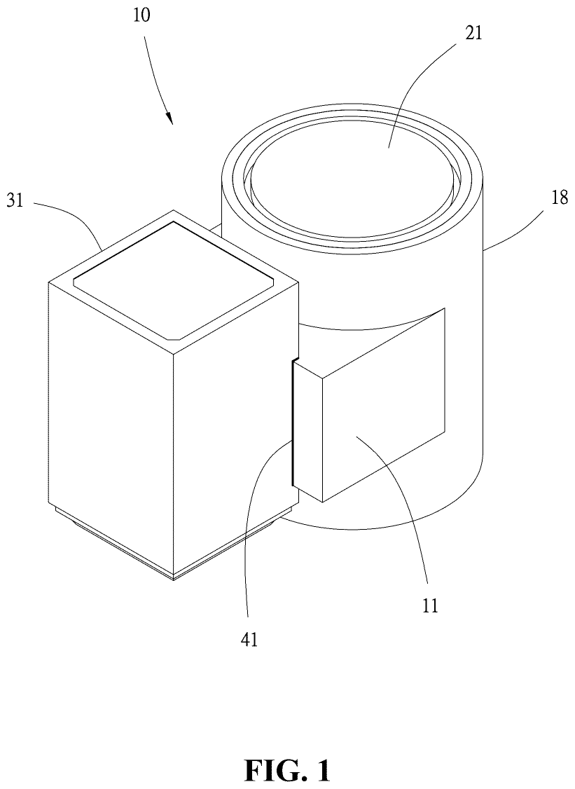

As shown in FIG. 1 through FIG. 3, the disclosure provides a positioning structure 10 for holding two parallel lenses of an endoscope relative to each other, as illustrated by the first preferred embodiment of the disclosure, essentially comprising a separating-positioning component 11, a first lens module 21, and a second lens module 31.

The separating-positioning component 11 has a predetermined height in a vertical direction, the first lens module 21 fixed on the right side of the separating-positioning component 11, an upright abutting wall 12 defined on the left side of the separating-positioning component 11, clamping walls 14 extending leftward from the front end and rear end of the abutting wall 12 respectively so as to face each other and be upright, and a slot 16 formed jointly by the abutting wall 12 and the two clamping walls 14. In the first embodiment, a sleeve 18 is disposed on the right side of the separating-positioning component 11, and the first lens module 21 is fixedly disposed in the sleeve 18. Optionally, the sleeve 18 and the separating-positioning component 11 are integrally formed, as illustrated in FIG. 1 through FIG. 3.

The second lens module 31 is in the shape of an upright rectangular column with a rectangular cross-section. One end of the second lens module 31 abuts against the abutting wall 12. The second lens module 31 is constrained by the two clamping walls 14 and thus cannot move forward and backward relative to the separating-positioning component 11. The second lens module 31 is parallel to the first lens module 21. In practice, the first lens module 21 and the second lens module 31 are configured to capture images, and one of the first and second lens module 21, 31 can be selected to function as a projection lens for performing a projection function as needed.

The second lens module 31 is fixed to the separating-positioning component 11, allowing the first lens module 21 and the second lens module 31 to be positioned relative to each other using the separating-positioning component 11. In the first embodiment, the second lens module 31 is fixed to the separating-positioning component 11 using an adhesive 41. Being very thin, the adhesive 41 is difficult to illustrate in the drawings and is therefore represented in FIG. 1 by a bold black line.

The structural features of the first embodiment are described above. The fitting process and state in the first embodiment are described below.

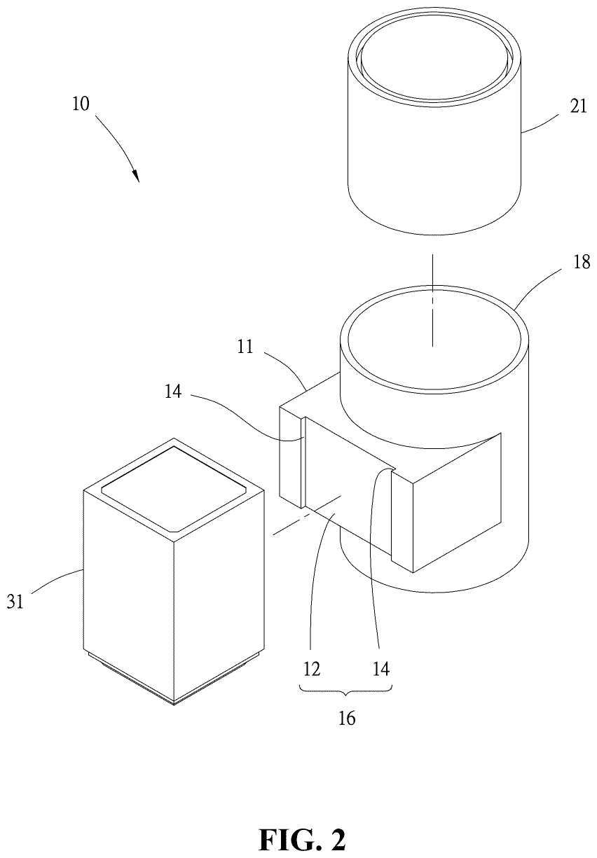

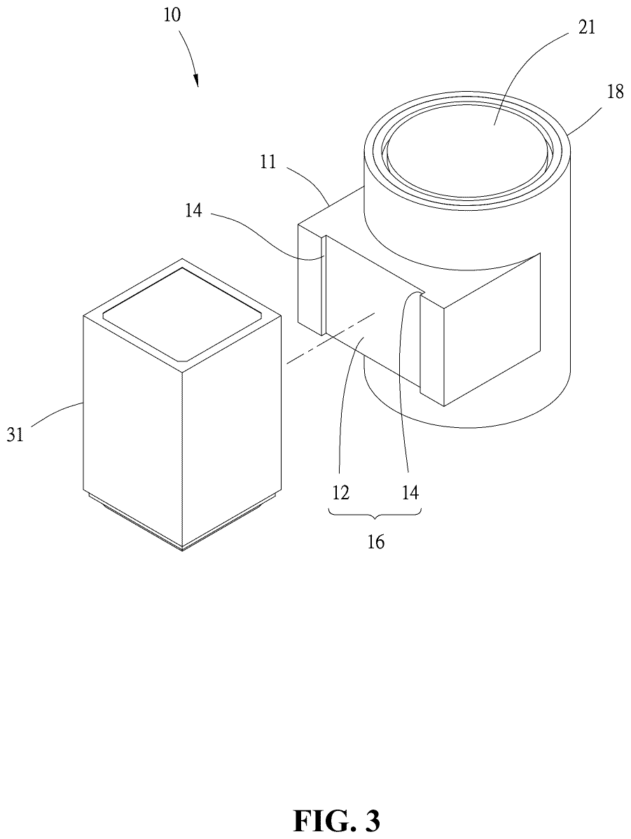

As shown in FIG. 2 and FIG. 3, the fitting process entails fixing the first lens module 21 in place inside the sleeve 18, using the slot 16 having not yet received the second lens module 31. As shown in FIG. 1, the fitting process entails allowing one end of the second lens module 31 to abut against the abutting wall 12 of the slot 16, with the two clamping walls 14 clamping the second lens module 31 to constrain the second lens module 31 to ensure that the second lens module 31 moves vertically, instead of forward and backward, relative to the separating-positioning component 11. After the second lens module 31 has moved vertically relative to the separating-positioning component 11 by its predetermined height, for example, become as high as the top end of the first lens module 21 as shown in FIG. 1, the fitting process further entails adhering and fixing the second lens module 31 to the separating-positioning component 11 using the adhesive 41. Upon completion of the fitting process, the second lens module 31 is positioned relative to the first lens module 21 using the separating-positioning component 11. Therefore, the disclosure is effective in enhancing fitting accuracy and enhancing yield.

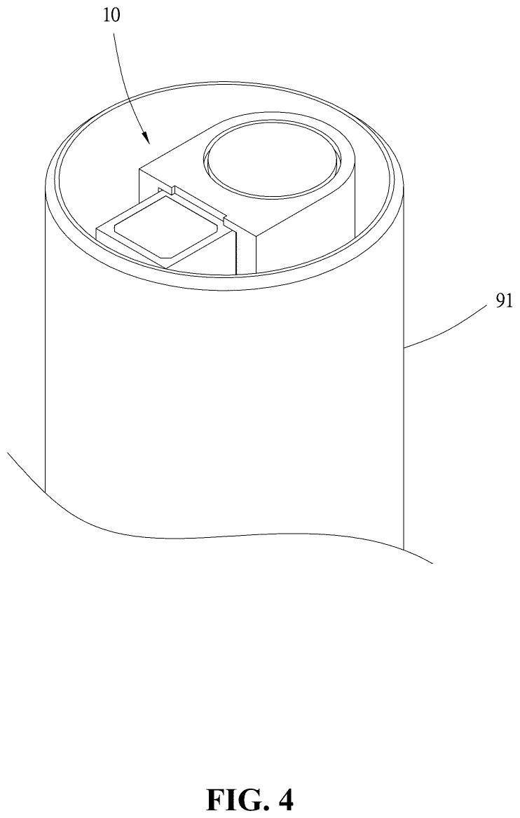

According to the disclosure, the positioning structure 10 for holding two parallel lenses of an endoscope relative to each other is mounted in place inside an endoscopic lens tube 91, as shown in FIG. 4.

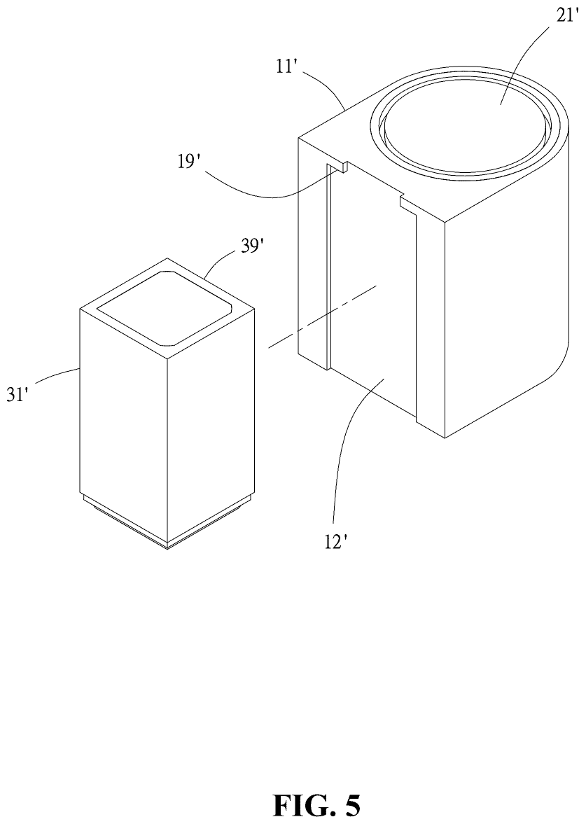

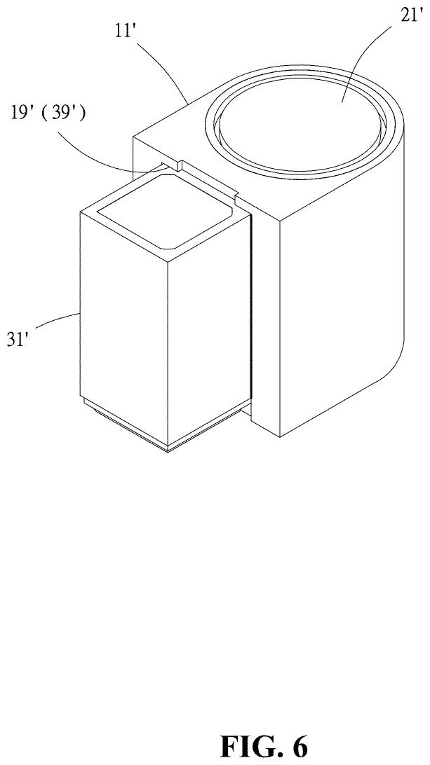

As shown in FIG. 5 through FIG. 6, in the first embodiment, the separating-positioning component 11′ comprises a stopper 19′. The stopper 19′ is located at the top edge of the abutting wall 12′. The second lens module 31′ has a stopping portion 39′ abutting against the stopper 19′ and thus can no longer move upward relative to the separating-positioning component 11′. As shown in FIG. 6, a top edge of the second lens module 31′ functions as the stopping portion 39′ to facilitate the movement of the second lens module 31′ relative to the separating-positioning component 11′ to fix its height. If the stopper 19′ is located at the lower half, as opposed to the upper half, in FIG. 5 and FIG. 6, the second lens module 31′ will abut against the stopper 19′ and thus can no longer move downward relative to the separating-positioning component 11′, as shown in FIG. 5 and FIG. 6, and thus they are, for the sake of brevity, not reiterated below. Referring to FIG. 6, the second lens module 31′ abuts against the stopper 19′ and thus differs from the first lens module 21′ in terms of the height of top edges on an exemplary basis. In practice, manufactures' needs must be taken into account when implementing the disclosure.

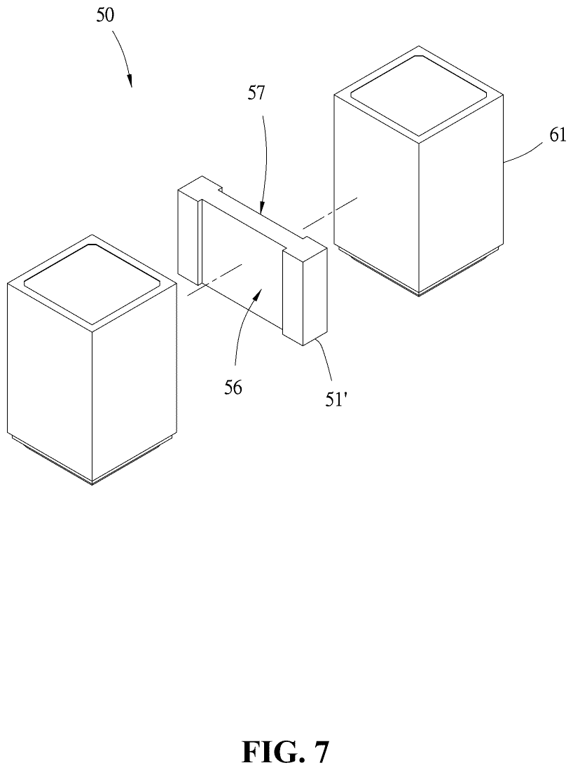

As shown in FIG. 7, a positioning structure 50 for holding two parallel lenses of an endoscope relative to each other according to the second preferred embodiment is distinguished from the positioning structure 10 for holding two parallel lenses of an endoscope relative to each other according to the first embodiment by technical features described below.

A right slot 57, as opposed to the sleeve 18 disclosed in the first embodiment, is disposed on the right side of the separating-positioning component 51. The right slot 57 corresponds to the slot 56 disposed on the left side of the separating-positioning component 51 in terms of cross-sectional shape.

The contour of the first lens module 61 is in the shape of an upright rectangular column with a rectangular cross-section. A portion of the first lens module 61 is embedded and fixed in the right slot 57 and thus constrained by the right slot 57.

The first lens module 61 is disposed at the separating-positioning component 51 in the second embodiment in the same way as the second lens module 31 is in the first embodiment and thus is, for the sake of brevity, not reiterated below.

The other structural features and achievable advantages of the second embodiment are the same as those of the first embodiment and thus are, for the sake of brevity, not reiterated below.

The disclosure is disclosed above by preferred embodiments. However, the embodiments shall not be interpreted as restrictive of the scope of the claims of the disclosure. All simple changes or equivalent implementation carried out to the embodiments according to the claims and specification of the disclosure shall be deemed to fall within the scope of the claims of the disclosure.

What is claimed is:

1. A positioning structure for holding two parallel lenses of an endoscope relative to each other, comprising:
a separating-positioning component having a predetermined height in a vertical direction, with a first lens module fixed on a right side thereof, an upright abutting wall defined on a left side thereof, clamping walls extending leftward from a front end and rear end of the abutting wall respectively so as to face each other and be upright, and a slot formed jointly by the abutting wall and the two clamping walls; and
a second lens module being in shape of an upright rectangular column with a rectangular cross-section, having an end abutting against the abutting wall, being parallel to the first lens module, being constrained by the two clamping walls and thus being unable to move forward and backward relative to the separating-positioning component,
wherein the second lens module is fixed to the separating-positioning component, allowing the first lens module and the second lens module to be positioned relative to each other using the separating-positioning component.

2. The positioning structure for holding two parallel lenses of an endoscope relative to each other according to claim 1, wherein a sleeve is disposed on the right side of the separating-positioning component, and the first lens module is fixedly disposed in the sleeve.

3. The positioning structure for holding two parallel lenses of an endoscope relative to each other according to claim 2, wherein the sleeve and the separating-positioning component are integrally formed.

4. The positioning structure for holding two parallel lenses of an endoscope relative to each other according to claim 1, wherein a right slot is disposed on the right side of the separating-positioning component and corresponds in cross-sectional shape to the slot disposed on the left side of the separating-positioning component, allowing a portion of the first lens module to be embedded and fixed in the right slot and thus constrained by the right slot.

5. The positioning structure for holding two parallel lenses of an endoscope relative to each other according to claim 1, wherein the second lens module is fixed to the separating-positioning component using an adhesive.

6. The positioning structure for holding two parallel lenses of an endoscope relative to each other according to claim 1, wherein the separating-positioning component has a stopper, and the second lens module has a stopping portion configured to abut against the stopper and being stopped.
